(19) United States
(12) Patent Application Publication
(10) Pub. No.: US 2026/0001562 A1
(43) Pub. Date: Jan. 1, 2026

(54) Method and Controller for Determining a Safety Integrity Level for a Safety-Related Vehicle Function of a Motor Vehicle

(71) Applicant: Robert Bosch GmbH, Stuttgart (DE)

(72) Inventor: Andreas Heyl, Weil Der Stadt (DE)

(21) Appl. No.: 18/880,698

(22) PCT Filed: Jul. 3, 2023
(86) PCT No.: PCT/EP2023/068217

§ 371 Date: Jan. 2, 2025

(30) Foreign Application Priority Data
Jul. 6, 2022 (DE) 10 2022 206 923.4

(51) Int. Cl. B60W 50/00

(52) U.S. Cl. CPC B60W 50/0098; B60W 2520/06; B60W 2520/10; B60W 2554/20; B60W 2554/40; B60W 2554/80; B60W 2556/45; B60W 2710/18; B60W 2710/20; B60W 2720/106

(57) ABSTRACT

A computer-implemented method for determining a safety integrity level of a safety-related vehicle function of a motor vehicle, includes providing at least one infrastructure and/or vehicle sensor data signal, which represents infrastructure and/or vehicle sensor data, which are intended for the safety-related vehicle function provided by the motor vehicle. The method further includes determining a safety integrity level of the safety-related vehicle function based on the infrastructure and/or vehicle sensor data signal provided; and allocating a calculation of the safety-related vehicle function to an in-vehicle and/or an off-vehicle system, taking into account a predetermined safety integrity of the in-vehicle and/or the off-vehicle system.

The invention relates to a method for determining a safety integrity level of a safety-related vehicle function of a motor vehicle.

Furthermore, the invention relates to a controller for determining a safety integrity level of a safety-related vehicle function of a motor vehicle.

Safety standards such as ISO 26262 describe the recommended procedure for developing safety-related functions. A first step is to determine the safety integrity of functions based on a risk analysis, e.g. the Hazard Analysis and Risk Assessment (HARA) in ISO 26262. This is carried out during the development period on the basis of assumptions about the use of the function or system containing the function in question.

In ISO 26262, for example, this is done via the parameter of a probability of occurrence of a situation in which a malfunction could be hazardous, the potential controllability of this malfunction, and a severity of the effect if this malfunction cannot be controlled in this situation. The assessment then provides a necessary level of safety integrity (e.g. ASIL) of a function on the basis of which the necessary development processes and safety mechanisms are derived from the safety standard.

This results in both applicable design and testing methods for the hardware and software as well as necessary ASIL compliance of hardware components on which the safety-related software later runs, which can be achieved, for example, by extensive diagnostics and by providing hardware redundancy.

DE102015200422A1 discloses a vehicle control and calculation system, comprising an in-vehicle task controller, a vehicle-specific calculation manager on a cloud network and a wireless data channel, which couples the task controller and the cloud network, wherein the task controller performs operational tasks in the vehicle using data-related resources in the cloud network, wherein, upon initiation of one of the operational tasks, the task controller sends an exchange signal to the calculation manager as a resource request, wherein the calculation manager calls at least one cloud-based agent from a database of predetermined agents in response to the exchange signal, and wherein the task controller completes the operational task by communicating with the called agent.

DE102019214453A1 discloses a method for safely performing a function provided by means of a motor vehicle, comprising the steps of: receiving infrastructure data signals which represent infrastructure data, which are intended for a function provided by means of a motor vehicle, receiving safety condition signals, which represent at least one safety condition which must be met to allow the function to execute on the basis of the infrastructure data, checking whether the at least one safety condition is satisfied, determining whether the function may be performed on the basis of the infrastructure data, generating result signals on the basis of a result of the check which represent a result of the determination and outputting the generated result signals.

Typically, the ASIL of a function is determined and fixedly assigned during the development period on the basis of assumptions about the “worst case” situations. However, by considering the plurality of possible situations, it is easily understood that the malfunction of a safety-related function is not at all dangerous in many of these situations. This applies to both primary functions such as actuator control, e.g., an unwanted motor stop while stationary, as well as secondary functions such as environmental perception, e.g., object detection in remote areas while driving slowly.

The invention thus addresses the problem of providing an improved method and controller for determining a safety integrity level for a safety-related vehicle function of a motor vehicle, which enables a safety integrity level of a safety-related vehicle function to be determined depending on the situation.

The task is solved with a computer-implemented method for determining a safety integrity level of a safety-related vehicle function of a motor vehicle with the features of claim 1.

Furthermore, the task is solved with a controller for determining a safety integrity level of a safety-related vehicle function of a motor vehicle with the features of claim 13.

Further, the task is solved with a computer program having the features of claim 14 and a computer-readable data storage medium having the features of claim 15.

### DISCLOSURE OF THE INVENTION

The present invention creates a computer-implemented method for determining a safety integrity level of a safety-related vehicle function of a motor vehicle.

The method comprises providing at least one infrastructure and/or vehicle sensor data signal representing infrastructure and/or vehicle sensor data determined for a safety-related vehicle function provided by a motor vehicle.

Furthermore, the method comprises determining the safety integrity level of the safety-related vehicle function based on the at least one provided infrastructure and/or vehicle sensor data signal. The method further comprises an allocation of a calculation of the safety-related vehicle function to an in-vehicle and/or an off-vehicle system, taking into account a predetermined safety integrity of the in-vehicle and/or the off-vehicle system.

The safety integrity level of the vehicle function represents or describes a degree or a level or a stage of the safety integrity of the vehicle function. The safety integrity of the vehicle function refers in particular to a reliability of the vehicle function, which can be determined, for example, by means of a risk assessment.

The safety integrity of the in-vehicle and/or the off-vehicle system can be represented, for example, by an ASIL score or ASIL value.

The present invention further creates a controller for determining a safety integrity level of a safety-related vehicle function of a motor vehicle.

The controller comprises means for receiving the at least one infrastructure and/or vehicle sensor data signal representing infrastructure and/or vehicle sensor data determined for a safety-related vehicle function provided by means of a motor vehicle.

Further, the controller comprises means for determining a safety integrity level of the safety-related vehicle function based on the provided infrastructure and/or vehicle sensor data signal. The controller also comprises means for allocating a calculation of the safety-related vehicle function to an in-vehicle and/or an off-vehicle system, taking into account a predetermined safety integrity of the in-vehicle and/or the off-vehicle system.

The present invention further creates a computer program with program code to perform the method according to the invention when the computer program is executed on a computer, and a computer readable data storage media with program code of a computer program to perform the method according to the invention when the computer program is executed on a computer.

Typically, a safety-related function is implemented by dedicated software developed for this purpose with the corresponding ASIL and implemented on dedicated hardware developed for this purpose with the corresponding ASIL. In traditional vehicle E/E architectures, there are therefore no advantages to implementing functions dynamically on hardware and with software with different ASILs, as the corresponding hardware and software are already available.

However, future vehicle E/E architectures will be highly networked with external systems such as cloud, edge, other vehicles, and/or smart devices. This offers the option of outsourcing functions externally. However, the ASIL of a function is a limitation for this outsourcing, as these external systems were often not developed according to a safety standard such as ISO 26262 and thus do not offer the necessary “ASIL compliance”.

One idea of the present invention is therefore to provide a dynamic, in particular real-time determination of the ASIL of safety-related functions and/or to enable sub-functions based on a currently given context, e.g. a driving situation and/or a vehicle state.

Thus, a controlled outsourcing of these functions or sub-functions to external systems can be performed in an advantageous manner, taking into account the given safety integrity of these external systems.

According to a preferred further development, it is contemplated that the allocation of the calculation of the safety-related vehicle function to the in-vehicle and/or the off-vehicle system is carried out if the predetermined safety integrity of the in-vehicle and/or the off-vehicle system satisfies the particular safety integrity level of the safety-related vehicle function.

Thus, safety-related functions can also be dynamically outsourced from the vehicle per se in order to release internal resources or use them for more complex safety-related calculations. This is particularly advantageous for automated driving functions, such as an environmental perception, adaptive behavior planning, and/or a trajectory planning, the calculation cost of which can vary dynamically and greatly depending on the given driving situation, e.g., a complexity of the driving situation and the environment.

According to a further preferred further development, it is provided that the at least one provided infrastructure and/or vehicle sensor data signal comprises travel situation parameters, in particular a vehicle speed, a direction of movement and/or a geographic position, of an ego vehicle, in particular the motor vehicle. Thus, a current driving situation is accurately depicted in the infrastructure and/or vehicle sensor data signal.

According to another preferred further development, it is provided that the at least one infrastructure and/or vehicle sensor data signal provided comprises or is a criticality parameter of a current driving situation, in particular a distance and/or a relative movement of the motor vehicle in relation to static and/or dynamic objects in certain areas of a vehicle environment.

As a result, the criticality of the current driving situation may also be included in determining the safety integrity level of the safety-related vehicle function.

According to another preferred further development, it is provided that the at least one infrastructure and/or vehicle sensor data signal provided comprises or consists of regions stored in a map in which predetermined object types, in particular persons and/or vehicles, are not located with a predetermined minimum probability as well as regions defined relative to the motor vehicle. As such, infrastructure data may also be included in determining the safety integrity level of the safety-related vehicle function.

In accordance with another preferred further development, it is contemplated that the determination of the safety integrity level of the safety-related vehicle function comprises dynamically classifying a vehicle environment using a classification algorithm, wherein the classification algorithm is applied to the at least one infrastructure and/or vehicle sensor data signal provided, and outputs a plurality of classes representing the safety integrity level of the safety-related vehicle function. The safety integrity level determined in this way, in particular the ASIL, therefore serves as the basis for allocating the calculation of the safety-related vehicle function to an in-vehicle and/or an off-vehicle system.

According to another preferred further development, it is provided that the safety-related vehicle function is a steering, braking, and/or acceleration function of the vehicle.

This allows for a determination of whether, for example, unwanted braking is hazardous because a vehicle is behind the motor vehicle or not. Likewise, this makes it possible to assess whether or not unwanted steering or braking is hazardous depending on the vehicle speed and vehicle environment.

According to a further preferred further development, it is provided that the safety-related vehicle function is an environmental detection function that captures which regions of an environment model to be calculated are relevant for determining a safe behavior of the motor vehicle and which are not.

For example, detection of traffic lights is relevant or not in a region depending on the situation, e.g., it is less relevant for objects that are well ahead at a low ego vehicle speed, as well as if there are known to be no traffic lights present on the route or they are known to be deactivated; such data can be obtained from static or dynamic map information.

Furthermore, traffic light detection is less relevant, for instance, if there are known to be no traffic lights in certain viewing regions, in the case of driving on a highway, in the viewing region on the left or straight ahead in the case of a right curve, as well as when starting the vehicle.

Further, detection of persons is less relevant or less critical to safety for areas that are farther away or blocked off, from which persons realistically cannot reach the region in front of the vehicle, as well as regions in which persons cannot realistically be located, e.g., in a tunnel or on a highway.

According to another preferred further development, it is contemplated that the safety integrity level of the safety-related vehicle function is determined based on a real-time criticality, particularly using at least one real-time infrastructure and/or vehicle sensor data signal.

The real-time criticality of the data thus enables real-time outsourcing or allocating the calculation of the safety-related vehicle function to an in-vehicle and/or an off-vehicle system.

According to another preferred further development, it is provided that resources available in the vehicle and in the vehicle environment are determined for calculating the safety-related vehicle function, in particular the safety integrity level of a required control device and/or a computer-implemented method operated on the control device, as well as a maximum latency required for calculating the safety-related vehicle function via these resources.

This data can thus also be stored locally in the vehicle in a database (e.g. integrity/performance map of the resources available from a regional position).

According to another preferred further development, it is contemplated that the allocation of the calculation of the safety-related vehicle function with a safety integrity level that is below a predetermined threshold value is carried out on the vehicle controller.

Thus, for example, execution of the software on an internal controller, on the “safety” core (e.g. Lockstep-CPU) of the controller corresponding to a high ASIL, execution on a less secured core, e.g., with only a “QM grading”, execution on redundant GPUs, with comparison of the results corresponding to a high ASIL and/or execution on a single GPU with lower ASIL or “QM grading” can be facilitated.

According to a further preferred further development, it is provided that functional execution via V2X is requested on an external system, in particular an edge, fog and/or cloud server, a controller of another road user and/or a smart device, in particular a smartphone.

Thus, execution on an external system designed to be at a high safety integrity level, execution on redundant, external systems with a low safety integrity or pure “QM grading,” with local comparison of results for a higher safety integrity (“SW Lockstep”), and execution on a single external system with low safety integrity or pure “QM grading” may be enabled.

The described embodiments and further developments may be combined with one another as desired.

Further possible configurations, refinements, and implementations of the invention also comprise not explicitly mentioned combinations of features of the invention described above or below with respect to exemplary embodiments.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the mentioned advantages become apparent from the drawings. The illustrated elements of the drawings are not necessarily shown to scale with respect to one another.

The figures show:

FIG. 1 a flow chart of a computer-implemented method for determining a safety integrity level of a safety-related vehicle function of a motor vehicle according to a preferred embodiment of the invention; and

FIG. 2 a schematic diagram of a controller for determining a safety integrity level of a safety-related vehicle function of a motor vehicle according to the preferred embodiment of the invention.

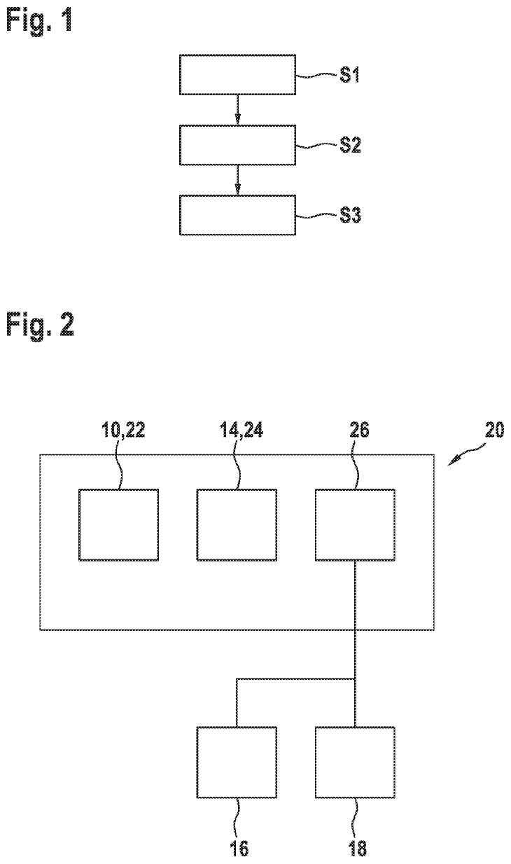

The computer-implemented method shown in FIG. 1 for determining a safety integrity level 14 of a safety-related vehicle function 12 of a motor vehicle comprises providing S1 of at least one infrastructure and/or vehicle sensor data signal 10 representing infrastructure and/or vehicle sensor data intended for a safety-related vehicle function 12 provided by means of a motor vehicle.

The safety-related vehicle function is understood to be a safety-relevant aspect of the vehicle, such as an accelerating, braking, and/or steering engagement function.

The method further comprises determining S2 a safety integrity level 14 of the safety-related vehicle function 12 based on the at least one infrastructure and/or vehicle sensor data signal 10 provided and allocating S3 a calculation of the safety-related vehicle function 12 to an in-vehicle and/or an off-vehicle system 16, 18 taking into account a predetermined safety integrity of the in-vehicle and/or off-vehicle system 16, 18.

The allocation of the calculation of the safety-related vehicle function 12 is carried out on the in-vehicle and/or the off-vehicle system 16, 18 if the predetermined safety integrity of the in-vehicle and/or the off-vehicle system 16, 18 satisfies the determined safety integrity level 14 of the safety-related vehicle function 12.

The at least one infrastructure and/or vehicle sensor data signal 10 provided includes driving situation parameters, particularly a vehicle speed, a direction of movement, and/or a geographic position, of an ego vehicle, particularly the motor vehicle.

The provided infrastructure and/or vehicle sensor data signal 10 further comprises or is a criticality parameter of a current driving situation, in particular a distance and/or a relative movement of the vehicle in relation to static and/or dynamic objects in certain regions of a vehicle environment. Moreover, the at least one infrastructure and/or vehicle sensor data signal 10 provided is regions stored in a map in which predetermined object types, in particular persons and/or vehicles, are not located with a predetermined minimum probability and regions defined relative to the motor vehicle.

Determining the safety integrity level 14 of the safety-related vehicle function 12 comprises dynamically classifying a vehicle environment using a classification algorithm.

The classification algorithm is applied to the at least one infrastructure and/or vehicle sensor data signal 10 provided and outputs a plurality of classes representing the safety integrity level 14 of the safety-related vehicle function 12. The output classes are different safety integrity levels 14, in particular different ASILs, of the safety-related vehicle function 12.

The safety-related vehicle function 12 is a steering, braking, and/or acceleration function of the motor vehicle. Further, the safety-related vehicle function 12 is an environmental detection function that captures which regions of an environment model to be calculated are relevant and which are not for determining a safe behavior of the motor vehicle.

The safety integrity level 14 of the safety-related vehicle function 12 is determined based on a real-time criticality, particularly using real-time infrastructure and/or vehicle sensor data signals 10.

In the vehicle and in the vehicle environment, available resources are determined for calculating the safety-related vehicle function 12, in particular the safety integrity level 14 of a required controller and/or a computer-implemented method operated on the controller 20. Further, a maximum latency required via these resources to calculate the safety-related vehicle function 12 is determined. The allocation of the calculation of the safety-related vehicle function 12 whose safety integrity level 14 is below a predetermined threshold value is carried out on the controller 20.

A functional execution via V2X is requested on an external system, in particular an edge server, fog, cloud, controller 20 of another road user, or a smart device. Vehicle-to-everything V2X is the communication between a vehicle and any device that may influence or be influenced by the vehicle.

FIG. 2 shows a schematic diagram of a controller for determining a safety integrity level 14 of a safety-related vehicle function 12 of a motor vehicle according to the preferred embodiment of the invention.

The controller 20 comprises means 22 for receiving at least an infrastructure and/or vehicle sensor data signal 10 representing infrastructure and/or vehicle sensor data determined for a safety-related vehicle function 12 provided by a motor vehicle.

Further, the controller 24 comprises means for determining a safety integrity level 14 of the safety-related vehicle function 12 based on the at least one infrastructure and/or vehicle sensor data signal 10 provided.

The controller also comprises means 26 for allocating S3 a calculation of the safety-related vehicle function 12 to an in-vehicle and/or an off-vehicle system, taking into account a predetermined safety integrity of the in-vehicle and/or off-vehicle system.

1. A computer-implemented method for determining a safety integrity level of a safety-related vehicle function of a motor vehicle, comprising:
providing at least one infrastructure and/or vehicle sensor data signal representing infrastructure and/or vehicle sensor data determined for the safety-related vehicle function provided by the a motor vehicle;
determining the safety integrity level of the safety-related vehicle function based on the provided at least one infrastructure and/or vehicle sensor data signal; and
allocating a calculation of the safety-related vehicle function to an in-vehicle and/or an off-vehicle system taking into account a predetermined safety integrity of the in-vehicle and/or the off-vehicle system.

2. The computer-implemented method of claim 1, wherein the allocation of the calculation of the safety-related vehicle function to the in-vehicle and/or the off-vehicle system is carried out when the predetermined safety integrity of the in-vehicle and/or the off-vehicle system satisfies the determined safety integrity level of the safety-related vehicle function.

3. The computer-implemented method of claim 1, wherein the at least one infrastructure and/or vehicle sensor data signal provided comprises driving situation parameters, including a vehicle speed, a direction of movement, and/or a geographic position, of the motor vehicle.

4. The computer-implemented method of claim 1, wherein the at least one infrastructure and/or vehicle sensor data signal provided comprises a criticality parameter of a current driving situation, including a distance and/or movement of the motor vehicle relative to static and/or dynamic objects in certain regions of an environment of the motor vehicle.

5. The computer-implemented method of claim 1, wherein the infrastructure and/or vehicle sensor data signal provided comprises regions stored in a map where predetermined object types, including people and/or vehicles, are not located with a predetermined minimum probability, as well as regions defined relative to the motor vehicle.

6. The computer-implemented method of claim 1, wherein:
determining the safety integrity level of the safety-related vehicle function comprises dynamically classifying an a environment of the motor vehicle using a classification algorithm, and
the classification algorithm is applied to the at least one infrastructure and/or vehicle sensor data signal provided, and outputs a plurality of classes representing the safety integrity level of the safety-related vehicle function.

7. The computer-implemented method of claim 1, wherein the safety-related vehicle function is a steering, braking, and/or acceleration function of the motor vehicle.

8. The computer-implemented method of claim 1, wherein the safety-related vehicle function is an environmental sensing function that senses which regions of an environmental model to be calculated are relevant to determining a safe behavior of the motor vehicle and which are not relevant to determining the safe behavior of the motor vehicle.

9. The computer-implemented method of claim 1, wherein the safety integrity level of the safety-related vehicle function is determined based on a real-time criticality, using real-time infrastructure and/or vehicle sensor data signals.

10. The computer-implemented method of claim 1, wherein:
resources available in the motor vehicle and in an environment of the motor vehicle to calculate the safety-related vehicle function, including the safety integrity level of a required controller and/or a computer-implemented method operated on the controller, are determined, and
a maximum latency required for calculating the safety-related vehicle function using these resources is determined.

11. The computer-implemented method of claim 10, wherein the allocation of the calculation of the safety-related vehicle function with a safety integrity level below a predetermined threshold value is carried out on the controller.

12. The computer-implemented method of claim 1, wherein a function execution via V2X on an external system, including an edge server, fog, cloud, controller of another road user, smart device, is requested.

13. A controller for determining a safety integrity level of a safety-related vehicle function of a motor vehicle, the controller configured to:
provide at least an infrastructure and/or vehicle sensor data signal representing infrastructure and/or vehicle sensor data determined for a safety-related vehicle function provided the motor vehicle;
determine the safety integrity level of the safety-related vehicle function based on the provided at least one infrastructure and/or vehicle sensor data signal; and
allocate a calculation of the safety-related vehicle function to an in-vehicle and/or an off-vehicle system, taking into account a predetermined safety integrity of the in-vehicle and/or the off-vehicle system.

14. The computer-implemented method of claim 1, wherein a computer program comprises program code for performing the method when the computer program is executed on a computer.

15. A non-transitory computer-readable data storage medium comprising the program code of the computer program according to claim 14.
